(19) United States
(12) Patent Application Publication
(10) Pub. No.: US 2024/0208240 A1
(43) Pub. Date: Jun. 27, 2024

(54) DROPLET PROCESSING DEVICE

(71) Applicant: SEMES CO., LTD., Cheonan-si (KR)

(72) Inventor: Yong-Deuk CHEONG, Cheonan-si (KR)

(73) Assignee: SEMES CO., LTD., Cheonan-si (KR)

(21) Appl. No.: 18/390,705

(22) Filed: Dec. 20, 2023

(30) Foreign Application Priority Data
Dec. 27, 2022 (KR) 10-2022-0185173
Jan. 26, 2023 (KR) 10-2023-0010197

(51) Int. Cl. B41J 2/21

(52) U.S. Cl. CPC B41J 2/2128; B41J 2/2132

(57) ABSTRACT

Disclosed is a droplet processing device which improves an operation of generating a droplet image during the conventional operation of generating a droplet image for forming a thin film on a substrate, thereby significantly reducing the generation time of the droplet image.

The droplet processing device includes: an inkjet system for receiving input of a droplet image and applying ink to cause the droplet image to be printed on a substrate; and a droplet image generating terminal for transmitting the droplet image to the inkjet system, in which the droplet image is generated by collecting a plurality of cell print data printed on the substrate and peripheral print data printed on a periphery of the cell into single polygonal information, and rasterising and halftoning the collected polygonal information.

### CROSS-REFERENCE TO RELATED APPLICATIONS

This application claims priority to and the benefit of Korean Patent Application Nos. 10-2022-0185173 and 10-2023-0010197 filed in the Korean Intellectual Property Office on Dec. 27, 2022 and Jan. 26, 2023 the entire contents of which are incorporated herein by reference.

### TECHNICAL FIELD

The present invention relates to a droplet processing device, and more particularly, to a droplet processing device for processing an image of a droplet.

### BACKGROUND ART

The method of manufacturing display substrates, photovoltaic substrates, and semiconductor substrates using inkjet has the advantage that a pattern layer can be formed without conventional processes, such as deposition, exposure, and development, by simply performing printing with ink, so that in terms of manufacturing cost, it has the advantage of being able to manufacture a substrate at a relatively lower cost than other substrate manufacturing methods.

In the method of manufacturing a substrate by using inkjet, printing is performed for the purpose of forming an organic layer, an insulating layer, a conductive layer, or an encapsulation layer in the form of a pattern on a substrate having an element formed on an upper surface of a glass.

In this case, the substrate is not printed with a single cell for a single product, but rather a plurality of cells is formed on a substrate, and a process of sawing each of the plurality of cells is applied after the end of the process to make a product.

For example, when the substrate is an A3 (6G Half) panel with a flat panel size of 1500 mm wide*925 mm long, 10 cells is formed based on a 24-inch to 27-inch monitor panel, and in this case, each of the 10 cells may be printed in a variable shape or size according to the customer's needs.

In this case, in order to apply ink to 10 cells to form a thin film, first, graphic file information, which includes information about a size of each of the 10 cells and information about a device pattern and circuit pattern mounted inside the 10 cells, is parsed, the parsed graphic information is converted to polygon information, which is vector information, and then from the converted polygon information, location information of an outer line of the cell is extracted while excluding the vector information.

Next, after the location information about the outer line of the cell is rasterised, the rasterised location information is converted to thin film data.

Next, when a fence region exists to discriminate the outer edge of the thin data, the fence region is rendered on the outer edge of the thin film data and then rasterised and synthesized to the thin film data.

Next, after the thin film data for the fence region is formed, edge regions are rendered to adjust the thickness of the edge regions that are formed at the outermost edge, and then the edge regions are rasterised and the thin film data including the fence region is synthesized.

After that, the excess region of the synthesized image including the fence region and the edge region is corrected for the average value, and the corrected synthesized image is re-rendered and separated into thin film regions, fence regions, edge regions, and excess regions, respectively, and a final droplet image is formed by performing halftoning processing on each of the thin film regions, excess regions, fence regions, and edge regions.

The print image generated as described above generates droplet images for a plurality of layers in each of the 10 cells.

In this case, the most computational operation to form the layers as described above corresponds to the pixel searching operation performed during rendering and rasterisation for each raster layer.

This pixel searching operation is performed repeatedly to average the thicknesses of the sections in which thin regions, the excess regions, the fence regions, and the edge regions each overlap to have increase thickness when rasterising each of the thin region, the excess region, the fence region, and the edge region.

As a result, the total operation time is the time taken for searching 3.9 billion pixels per layer for each of the thin regions, the fence regions, the edge regions, and the excess regions based on an A3 (6G Half) glass, and the number of operations needs to repeatedly progress for each sub-operation along with the number of layers, until the final droplet image is generated. Because of this operation process, it currently takes approximately 14 minutes to generate a final droplet image for an A3 (6G Half) glass with a resolution of 3.9 billion pixels.

On the other hand, customers are increasingly demanding different shapes and applications for their panels, and as a result, thin film shapes are becoming very complex and the number of layers is increasing dramatically.

As a result, there is a problem in that the operation involved in generating the final droplet image as described above continues to increase, increasing manufacturing time.

### SUMMARY OF THE INVENTION

A technical object of the present invention to solve the foregoing problems is to provide a droplet processing device which improves an operation of generating a droplet image during the conventional operation of generating a droplet image for forming a thin film on a substrate, thereby significantly reducing the generation time of the droplet image.

Another technical object of the present invention to solve the foregoing problems is to provide a droplet processing device which reduces repeated pixel searching operations performed on each layer during an operation of generating a droplet image to one-time pixel searching operation.

Still another technical object of the present invention to solve the foregoing problems is to provide a droplet processing device which includes positional information, thickness information, and thin film information for a printing region in a droplet image during an operation of generating a droplet image to prevent a pixel searching operation from progressing on the printing region and each layer.

The object of the present invention is not limited thereto, and other objects not mentioned will be clearly understood by those of ordinary skill in the art from the following description.

An exemplary embodiment of the present invention provides a droplet processing device including: an inkjet system which receives a droplet image and applies ink for the droplet image to be printed on a substrate; and a droplet image generating terminal which transmits the droplet image to the inkjet system, in which the droplet image is generated by collecting a plurality of cell print data printed on the substrate and a peripheral print data printed on a periphery of the cell into single polygonal information, rasterizing the collected polygonal information and then halftoning.

According to the exemplary embodiment, the droplet image generating terminal may further include a size information generating unit which generates a size information of each cell by parsing a circuit pattern file for the cells generated on the substrate.

According to the exemplary embodiment, the droplet image generating terminal may further include an entire cell polygon information generating unit, which interworks with the size information generating unit and generates entire cell polygon information by collecting the size information of the cells.

According to the exemplary embodiment, the droplet image generating terminal may further include an edge polygon information generating unit, which interworks with the entire cell polygon information generating unit and generates edge polygon information in an edge region of the entire cell polygon information.

According to the exemplary embodiment, the edge polygon information may be formed by applying a scale factor to the entire cell polygon information to increase or decrease the entire cell polygon information by a certain percentage.

According to the exemplary embodiment, the droplet image generating terminal may further include a group-specific cell polygon information generating unit, which interworks with the edge polygon information generating unit, and generates group-specific cell polygon information by grouping each of the cells in the entire cell polygon information.

According to the exemplary embodiment, the droplet image generating terminal may further include a coordinate converting unit, which interworks with the entire cell polygon information generating unit, the edge polygon information generating unit, and the group-specific cell polygon information generating unit, and coordinates vertices that make up the entire cell polygon information, the edge polygon information, and the group-specific cell polygon information, respectively, and converts the coordinated vertices into vertex coordinate information.

According to the exemplary embodiment, the droplet image generating terminal may further include a fence polygon information generating unit, which interworks with the entire cell polygon information generating unit and generates a fence polygon information based on the entire cell polygon information.

According to the exemplary embodiment, the droplet image generating terminal may further include a cell rasterizing unit, which interworks with the coordinate converting unit and generates a cell raster image by rasterizing the vertex coordinate information. According to the exemplary embodiment, the droplet image generating terminal may further include a fence rasterizing unit, which interworks with the fence polygon information generating unit and generates a fence raster image by rasterizing the fence polygon information.

According to the exemplary embodiment, the droplet image generating terminal may further include an edge rasterizing unit, which interworks with the edge polygon information generating unit and generates an edge raster image by rasterizing the edge polygon information.

According to the exemplary embodiment, the cell raster image, the fence raster image, and the edge raster image may be formed in an image of 16 BPP or more.

According to the exemplary embodiment, the image formed in the 16 BPP or more may is that a region information is generated in any one of color information for a red channel, a green channel, and a blue channel.

According to the exemplary embodiment, the image formed in the 16 BPP or more may be that thickness information is generated in at least one color information, except for the color information in which the region information is generated, among the color information for the red channel, the green channel, and the blue channel.

According to the exemplary embodiment, a section in which each of the cell raster images, the fence raster images, and the edge raster images overlaps may be a section to which an average value of the thickness information is applied.

According to the exemplary embodiment, the droplet image generating terminal may further include a halftoning unit which generates a cell halftone image, a fence halftone image, and an edge halftone image by halftoning each of the cell raster image, the fence raster image, and the edge raster image.

According to the exemplary embodiment, the droplet image generating terminal may further include a droplet image management unit which stores the cell halftone image, the fence halftone image, and the edge halftone image as the droplet image, and transmits the droplet image to the inkjet system.

Another exemplary embodiment of the present invention provides a droplet processing device including: an inkjet system which receives a droplet image and applies ink for the droplet image to be printed on a substrate; and a droplet image generating terminal which transmits the droplet image to the inkjet system, in which the droplet image is rasterized into an image of 16 BPP or more during rasterization, and is that a region information is generated in any one of color information for a red channel, a green channel, and a blue channel within the image of 16 BPP or more.

According to the exemplary embodiment, thickness information may be generated in at least one color information, except for the color information in which the region information is generated, among the information for the red channel, the green channel, and the blue channel.

Still another exemplary embodiment of the present invention provides a droplet processing device including: an inkjet system which receives a droplet image and applies ink for the droplet image to be printed on a substrate; and a droplet image generating terminal which transmits the droplet image to the inkjet system, in which the droplet image generating terminal includes: a size information generating unit which generates size information for each cell by parsing a circuit pattern file for the cells generated on the substrate; an entire cell polygon information generating unit, which interworks with the size information generating unit and generates entire cell polygon information by collecting the size information of the cells; an edge polygon information generating unit, which interworks with the cell polygon information generating unit and generates edge polygon information in an edge region of the entire cell polygon information, and forms the edge polygon information by applying a scale factor to the entire cell polygon information to increase or decrease the entire cell polygon information by a certain percentage; a group-specific cell polygon information generating unit, which interworks with the edge polygon information generating unit, and generates group-specific cell polygon information by grouping each of the cells in the entire cell polygon information; a coordinate converting unit, which interworks with the entire cell polygon information generating unit, the edge polygon information generating unit, and the group-specific cell polygon information generating unit, and coordinates vertices that make up the entire cell polygon information, the edge polygon information, and the group-specific cell polygon information, respectively, and converts the coordinated vertices into vertex coordinate information; a fence polygon information generating unit, which interworks with the entire cell polygon information generating unit and generates fence polygon information based on the entire cell polygon information; a cell rasterizing unit, which interworks with the coordinate converting unit and generates a cell raster image by rasterizing the vertex coordinate information; a fence rasterizing unit, which interworks with the fence polygon information generating unit and generates a fence raster image by rasterizing the fence polygon information; an edge rasterizing unit, which interworks with the edge polygon information generating unit and generates an edge raster image by rasterizing the edge polygon information; a halftoning unit, which halftones each of the cell raster image, the fence raster image, and the edge raster image to generate a cell halftone image, a fence halftone image, and an edge halftone image; and a droplet image management unit, which stores the cell halftone image, the fence halftone image, and the edge halftone image as the droplet image, and transmits the droplet image to the inkjet system, and the cell raster image, the fence raster image, and the edge raster image are formed in an image of 16 BPP or more, the image formed in the 16 BPP or more is that a region information is generated in any one of color information for a red channel, a green channel, and a blue channel, the image formed in the 16 BPP or more is that a thickness information is generated in at least one color information, except for the color information in which the region information is generated, among the color information for the red channel, the green channel, and the blue channel, and a section in which each of the cell raster images, the fence raster images, and the edge raster images overlaps is a section to which an average value of the thickness information is applied.

The present invention has the following effects. It is possible to improve an operation of generating a droplet image during the conventional operation of generating a droplet image for forming a thin film on a substrate, thereby significantly reducing the generation time of the droplet image.

Further, it is possible to reduce repeated pixel searching operations performed on each layer during an operation of generating a droplet image to one-time pixel searching operation, thereby improving productivity.

Furthermore, positional information, thickness information, and thin film information for a printing region are included in a droplet image during an operation of generating a droplet image, thereby preventing a pixel searching operation from progressing on the printing region and each layer.

The effect of the present invention is not limited to the foregoing effects, and non-mentioned effects will be clearly understood by those skilled in the art from the present specification and the accompanying drawings.

### BRIEF DESCRIPTION OF THE DRAWINGS

FIG. 1 is a perspective view of a droplet processing device according to an exemplary embodiment of the present invention.

FIG. 2 is a detailed configuration diagram of a droplet image generating terminal illustrated in FIG. 1.

FIG. 3 is a diagram illustrating an example of the droplet image generating terminal displaying a state in which cells are formed on a substrate.

FIG. 4 is a diagram illustrating an example of the droplet image generating terminal displaying entire cell polygon information.

FIG. 5 is an example of the droplet image generating terminal displaying edge polygon information in an outer region of the entire cell polygon information.

FIG. 6 is a diagram illustrating an example of the droplet image generating terminal displaying group-specific cell polygon information.

FIG. 7 is a diagram illustrating an example of the droplet image generating terminal displaying vertex coordinate information that coordinates the vertices that make up the entire cell polygon information, the edge polygon information, and the group-specific cell polygon information, respectively.

FIG. 8 is a diagram illustrating an example of the droplet image generating terminal displaying fence polygon information based on the entire cell polygon information.

FIG. 9 is a diagram illustrating an example of the droplet image generating terminal displaying a cell raster image in which vertex coordinate information is rasterised.

FIG. 10 is a diagram illustrating an example of the droplet image generating terminal displaying a fence raster image in which fence polygon information is rasterised.

FIG. 11 is a diagram illustrating an example of the droplet image generating terminal displaying an edge raster image in which edge polygon information is rasterised.

FIG. 12 is a table showing the information assigned to each channel when a cell raster image, a fence raster image, and an edge raster image are represented as a 32 BPP bitmap image.

FIG. 13 is a diagram illustrating an example of a state in which thickness values are averaged when rasterised images overlap.

FIG. 14 is a diagram illustrating an example of a cell halftone image, a fence halftone image, and an edge halftone image.

FIGS. 15 and 16 are flowcharts of a droplet image generating method using the droplet processing device according to an exemplary embodiment of the present invention.

FIGS. 17 and 18 are flowcharts in which a method of forming a layer for each of a cell region, an edge region, a fence region, and a maximum thickness (EC MAC) region corresponding to a thin film using an 8BPP image with the droplet image generating method of the present invention.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

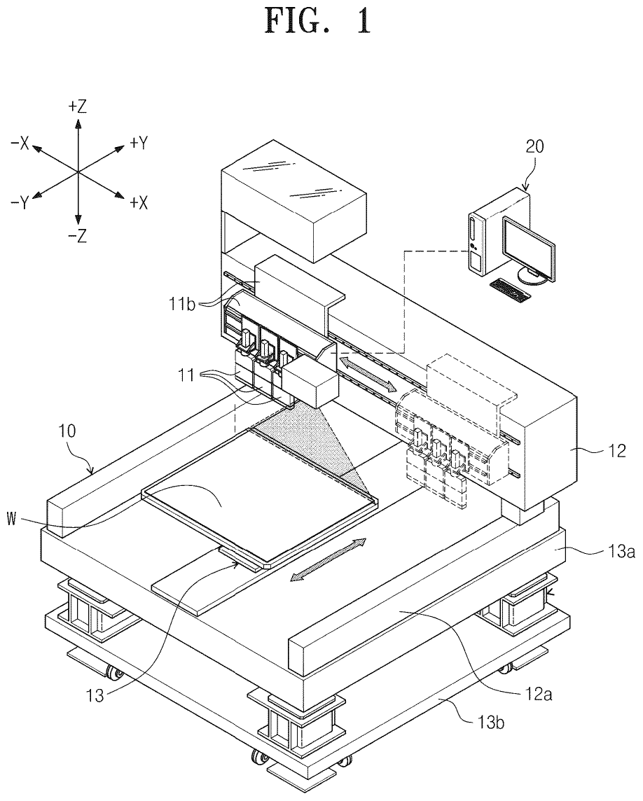

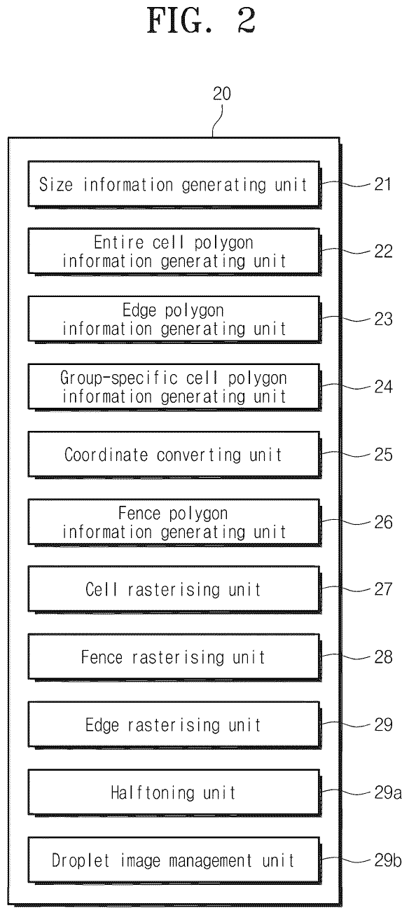

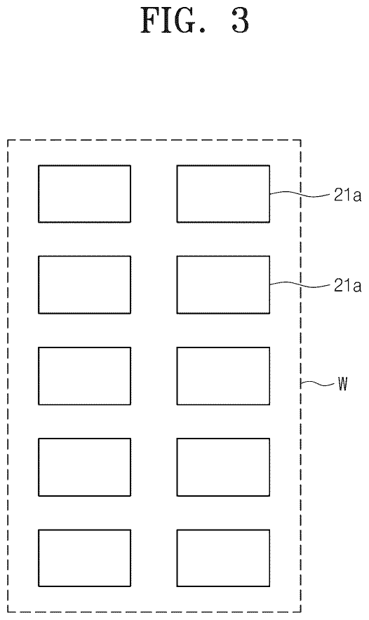

FIG. 1 is a perspective view of a droplet processing device according to an exemplary embodiment of the present invention. FIG. 2 is a detailed configuration diagram of a droplet image generating terminal illustrated in FIG. 1. FIG. 3 is a diagram illustrating an example of the droplet image generating terminal displaying a state in which cells are formed on a substrate.

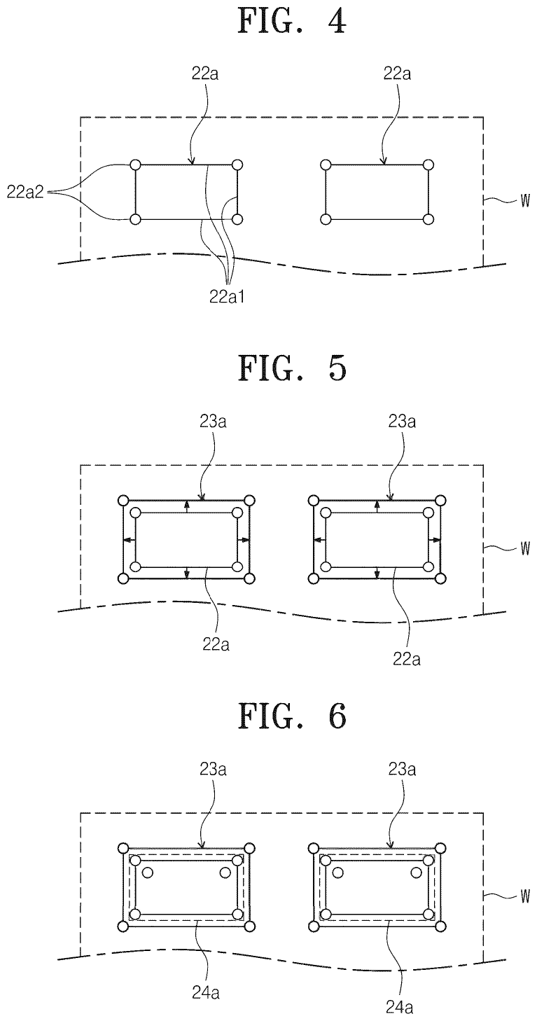

FIG. 4 is a diagram illustrating an example of the droplet image generating terminal displaying entire cell polygon information. FIG. 5 is an example of the droplet image generating terminal displaying edge polygon information in an outer region of the entire cell polygon information.

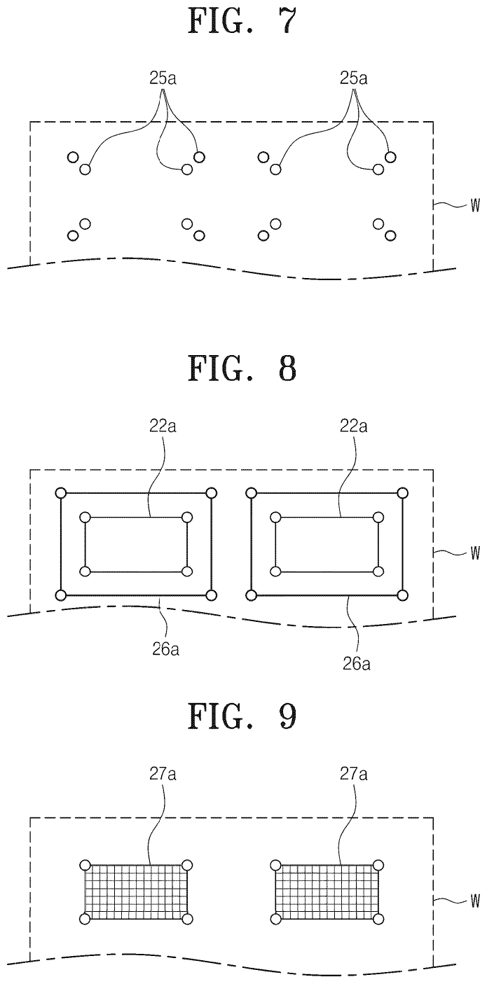

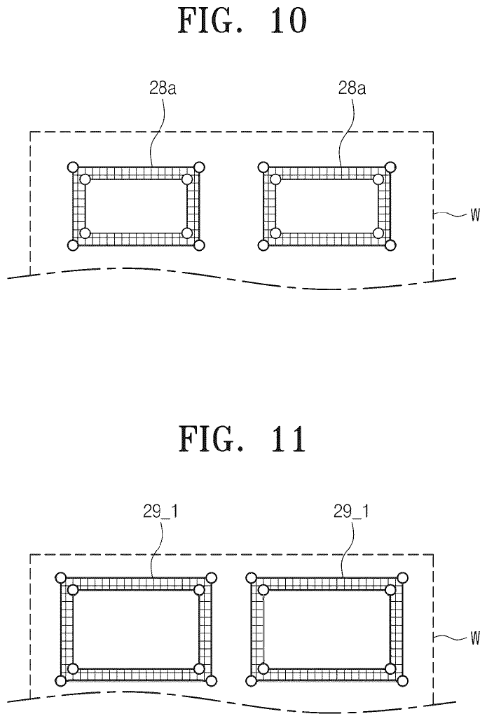

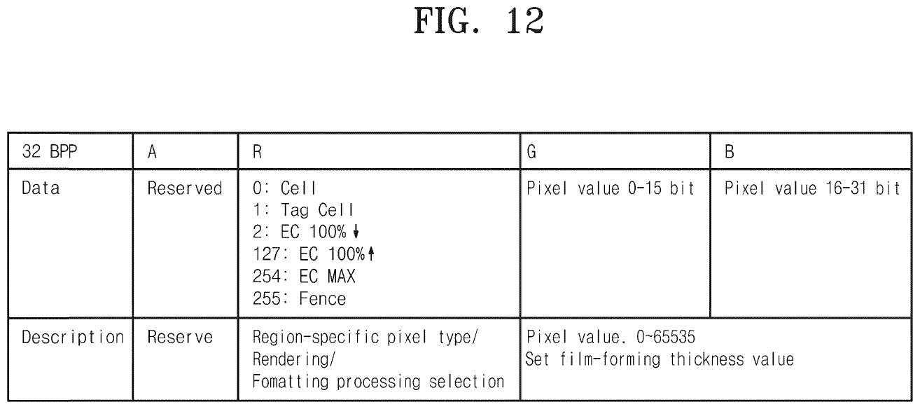

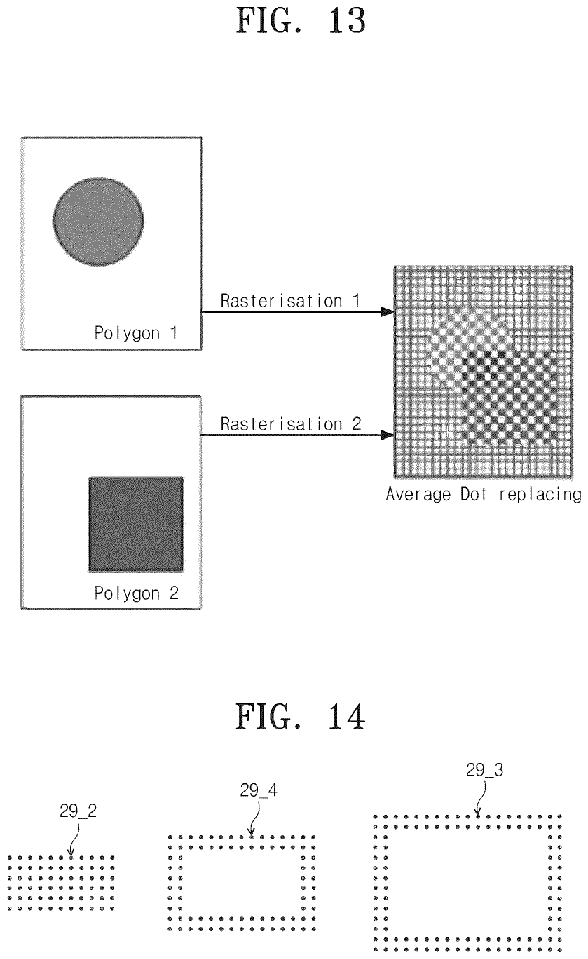

FIG. 6 is a diagram illustrating an example of the droplet image generating terminal displaying group-specific cell polygon information. FIG. 7 is a diagram illustrating an example of the droplet image generating terminal displaying vertex coordinate information that coordinates the vertices that make up the entire cell polygon information, the edge polygon information, and the group-specific cell polygon information, respectively. FIG. 8 is a diagram illustrating an example of the droplet image generating terminal displaying fence polygon information based on the entire cell polygon information. FIG. 9 is a diagram illustrating an example of the droplet image generating terminal displaying a cell raster image in which vertex coordinate information is rasterised. FIG. 10 is a diagram illustrating an example of the droplet image generating terminal displaying a fence raster image in which fence polygon information is rasterised. FIG. 11 is a diagram illustrating an example of the droplet image generating terminal displaying an edge raster image in which edge polygon information is rasterised. FIG. 12 is a table showing the information assigned to each channel when a cell raster image, a fence raster image, and an edge raster image are represented as a 32 BPP bitmap image. FIG. 13 is a diagram illustrating an example of a state in which thickness values are averaged when rasterised images overlap. FIG. 14 is a diagram illustrating an example of a cell halftone image, a fence halftone image, and an edge halftone image.

As illustrated in FIGS. 1 to 14, a droplet processing device according to an exemplary embodiment of the present invention includes an inkjet system 10 and a droplet image generating terminal 20.

The inkjet system 10 includes an inkpack assembly 11, a pack transfer part 12, and a substrate transfer part 13.

The inkpack assembly 11 includes a plurality of inkjet heads 11a formed in the form of an inkpack and combined. Each of the inkjet heads 11a is formed with a plurality of nozzles arranged at the bottom, and each of the inkjet heads 11a has tens to hundreds of nozzles arranged at the bottom, and each of the nozzles may discharge ink. In addition, each nozzle discharges ink when receiving an electrical signal according to an input print image value. Further, the inkjet heads 11a may be configured to include different colors of ink in respective packs. For example, each of the inkjet heads 11a may be formed by selecting a color of any one from a red channel, a green channel, and a blue channel. Furthermore, the nozzle may be formed by a piezo method of discharging ink by using a piezo element or a thermal transfer method using a heating element. The inkpack assemblies 11 are coupled to the pack transfer part 12 and are positioned at regular intervals to discharge ink onto a top surface of a substrate w being transferred by the substrate transfer part 13. In the case of the present exemplary embodiment, the direction in which the inkpack assembly 11 moves is in the longitudinal direction of the pack transfer part 12, and will be referred to as the X-axis direction, as shown in the drawings. Further, the inkpack assembly 11 may be formed to further include a coupling assembly 11b for securing the inkjet head 11a in a particular position. However, the present invention is not intended to limit the configuration of the inkpack assembly 11 to the above example, and it is a matter of course that the inkpack assembly 11 may be implemented with various forms to fix a plurality of inkjet heads 11a in a particular position.

The pack transfer part 12 is coupled with the inkpack assembly 11 and transfers the inkpack assembly 11 in the X-axis direction. As one example of the pack transfer part 12, the pack transfer part 12 may be formed of a linear motor that travels along a rail in one direction. Furthermore, the pack transfer part 12 may be disposed in the upper space of the substrate transfer part 13 and may be coupled with a base 12a, a lower side of which is formed on both sides of the substrate transfer part 13. However, the present invention does not limit the coupling method and the transfer direction of the pack transfer part 12 to the above example, and it is a matter of course that the coupling method and the transfer direction of the pack transfer part 12 may be implemented with various variations depending on the shape of the substrate w or the printing direction.

The substrate transfer part 13 holds the substrate w and transfers the substrate w. In this case, the substrate transfer part 13 may transfer the substrate w through driving preset by a substrate transfer control part (not shown). On the other hand, in the present exemplary embodiment, the transfer direction of the substrate w is referred to as the Y-axis direction relative to the plane. In this case, the y-axis direction is perpendicular to the x-axis direction. The substrate transfer part 13 moves the substrate w forward and backward. Here, the substrate w may be formed as a display substrate, and in the case of the present exemplary embodiment, the substrate w may be formed as a dummy substrate on which a test pattern 100 is printed. In addition, the substrate transfer part 13 may be seated on the top of a faceplate 13a and a base 13b to reduce vibration and make it movable.

Furthermore, the pack transfer part 12, the substrate transfer part 13, and a head position adjustment part as described above may be implemented with various variations in the coupling method or movement direction depending on the printing form of the substrate w, and the like, and it is a matter of course that there may be additional configurations not mentioned between the pack transfer part 12, the substrate transfer part 13, and the head position adjustment part as needed. For example, a head position adjustment unit 14 may be further formed between the pack transfer part 12 and the substrate transfer part 13 to rotate the pack transfer part 12 or move the pack transfer part 12 in the vertical direction in a plane.

The droplet image generating terminal 20 is a communication terminal device, such as a Personal Computer (PC) or laptop. The droplet image generating terminal 20 generates a droplet image for printing droplets. In this case, the droplet image generating terminal 20 is operated with an image generating program (not shown) installed to generate the droplet image, and the image generating program allows an operator to generate the droplet image by using an input device of a mouse and a keyboard. Here, the image generating program may generate size information 21a for an image by using graphical coordinate data on a two-dimensional plane, such as a CAD program, and may generate an image that includes brightness information, color information, and resolution information for each of the size information 21a. Furthermore, the image generating program may generate a droplet image by changing the size information 21a, brightness information, color information, and resolution information of the generated image, and may change the color information, brightness information, and resolution information of the image in batches by applying various graphic filters. In this case, the image generating program may form a droplet image by forming an entire region of the pixel value in an image in the form of dots by applying halftoning by using the brightness information and resolution information of the image when the entire region of the pixel value consists of one color information, and applying a random printing pattern that randomly distributes the number of images in the form of dots to which the halftoning has been applied within the unit plane region.

The droplet image is generated by collecting cell print data printed on the substrate and peripheral print data printed on a peripheral region of the cell into single polygon information, rasterising and halftoning the collected polygon information.

In one example of the droplet image generating terminal 20 for generating the droplet image, the droplet image generating terminal 20 includes a size information generating unit 21, an entire cell polygon information generating unit 22, an edge polygon information generating unit 23, a group-specific cell polygon information generating unit 24, a coordinate converting unit 25, a fence polygon information generating unit 26, a cell rasterising unit 27, a fence rasterising unit 28, an edge rasterising unit 29, a halftoning unit 29a, and a droplet image management unit 29b.

Hereinafter, before describing the above configurations, reference will be made to FIGS. 3 to 14, and herein, the polygon information is formed in a very complex shape depending on the shape of the droplet image, so that the polygon information is shown in a simplified state for ease of understanding in the drawings of the present invention.

As illustrated in FIG. 3, the size information generating unit 21 parses a circuit pattern file for the cells to be generated on the substrate and generates the size information 21a for each cell. In this case, the circuit pattern file may be formed as a GDSII file. However, the present invention does not limit the circuit pattern file to the GDSII file. Here, in the case of an A3 (6G Half) panel with a size of 1500 mm wide*925 mm long, the substrate may form 10 cells based on a 24-inch to 27-inch monitor panel, and in this case, each of the 10 cells may be printed with a variable shape or size according to the customer's needs.

The entire cell polygon information generating unit 22 interworks with the size information generating unit 21, as illustrated in FIG. 4, to collect the size information 21a of the cells and generate the collected size information as entire cell polygon information 22a. The entire cell polygon information 22a is formed by vertex information 22a1 containing position coordinate values for the shape of the cell, and line information 22a2 connecting the vertex information 22a1. In this way, the entire cell polygon information 22a is formed as vector information.

The edge polygon information generating unit 23 interworks with the entire cell polygon information generating unit 22, as illustrated in FIG. 5, to generate edge polygon information 23a in the edge region of the entire cell polygon information 22a. The edge polygon information 23a is formed by applying a scaling factor to the outermost line information of the entire cell polygon information 22a to increase or decrease the information by a certain percentage. In this case, multiple polygon information 23a may be formed at same spacing intervals, and regions of the polygon information 23a may have thickness information set for each other.

The group-specific cell polygon information generating unit 24 interworks with the edge polygon information generating unit 23, as illustrated in FIG. 6, to generate group-specific cell polygon information 24a by grouping each of the cells in the entire cell polygon information 22a. Here, the group-specific cell polygon information 24a may further include additional line information and coordinate information formed inside the cell. Additional line information and coordinate information may be further formed when separate line information is needed inside a cell, such as a camera hole.

The coordinate converting unit 25 interworks with the entire cell polygon information generating unit 22, the edge polygon information generating unit 23, and the group-specific cell polygon information generating unit 24, as illustrated in FIG. 7, and coordinates the vertices that make up the entire cell polygon information 22a, the edge polygon information 23a, and the group-specific cell polygon information 24a, respectively, and converts the coordinated vertexes into vertex coordinate information 25a. In this case, the vertex coordinate information 25a is simplified in the drawing for ease of understanding, but approximately 439,125 vertex information is generated for the A3 substrate, and in this case, the polygon information corresponds to approximately 3,393 polygons.

The fence polygon information generating unit 26 interworks with the entire cell polygon information generating unit 22, as illustrated in FIG. 8, to generate fence polygon information 26a based on the entire cell polygon information 22a. Here, the fence polygon information 26a may be generated by setting a certain spacing offset value based on the outermost coordinate information of each of the cells formed within the entire cell polygon information 22a, or by applying a scale factor to each of the cells. Such fence polygon information 26a is formed on the outer side of the cell and the edge region when the droplet image is printed, and corresponds to information for distinguishing the outer region of the cell from other cells.

The cell rasterising unit 27 interworks with the coordinate converting unit 25, as illustrated in FIG. 9, to rasterise the vertex coordinate information 25a and generate a cell raster image 27a in which the rasterised vertex coordinate information is converted to pixel values.

The fence rasterising unit 28 interworks with the fence polygon information generating unit 26, as illustrated in FIG. 10, to rasterise the fence polygon information 26a and generate a fence raster image 28a in which the rasterised fence polygon information 26a is converted to pixel values.

The edge rasterising unit 29 interworks with the edge polygon information generating unit 23, as illustrated in FIG. 11, to rasterise the edge polygon information 23a and generate an edge raster image 29_1 in which the rasterised edge polygon information 23a is converted to pixel values. In this case, the edge raster image 29_1 may be formed with a plurality of regions equally spaced apart from each other, and thickness information of a section in which the plurality of regions overlap may be calculated by summing the preset thickness value and the overlapping edge raster image 29_1, and then averaging the summed value.

Here, the cell raster image 27a, the fence raster image 28a, and the edge raster image 29_1 are formed as a 16 bit per pixel (BPP) or higher image of two or more channels, and may be formed, for example, as a 32 BPP bitmap image including four channels (A, R, G, B) as illustrated in FIG. 12. In this case, the red channel (R channel) is utilized as a thin film type identification tag, and the green channel (G channel) and the blue channel (B channel) are utilized as film thickness information. Accordingly, a single pixel may be formed while including thickness information from 0 to 65535 and even thin film type information. As a result, it is possible to provide thickness information and thin film type information in a single 32 BPP bitmap image, unlike conventional droplet images where multiple layers are formed in 8 BPP to identify thickness information and thin film information.

More specifically, when the droplet image is formed of a 32 BPP bitmap image, region information for any one of color information for the red channel, the green channel, and the blue channel is generated in the on the 32 BPP bitmap image. Herein, as an example of the region information, as illustrated in FIG. 12, the region information may be represented as 0 for the cell in the red channel, the region information may be represented as 1 for a tag cell used as identification information, the region information may be represented as 2 for a region for 100% or less of a reference thickness region (EC), the region information may be represented as 127 for a region for 100% or more of the reference thickness region (EC), the region information may be represented as 254 for a region having the maximum thickness beyond the reference thickness region (EC), and the region information may be represented as 255 for a fence region, as illustrated in FIG. 12. As described above, when the region information is generated on the R channel in the 32 BPP bitmap image, pixel types, rendering, and formatting may be selectively configured for each region information.

Further, the 32 BPP image includes thickness information of the thin film generated in at least one color information among the color information for the red channel, the green channel, and the blue channel, except for the color information in which the region information is generated.

For example, thickness information may be generated by selecting data values between 0 and 65535 as the thickness value increases among the allocated data of 0 and 65535 in the green channel and the blue channel. In the present exemplary embodiment, the thickness information is adjusted according to the value selected within the values from 0 to 510, and the thickness information may be generated by using the remaining data values as needed. In addition, channel A of the 32 BPP image is assigned as a spare channel, which may be used to enter other information required for printing as needed. Also, when the droplet image is formed as a 16 BPP image and consists of two channels, region information may be generated in one channel and thickness information may be generated in another channel. Also, when the droplet image is formed as a 16 BPP image and consists of two channels, region information may be generated in one channel and thickness information may be generated in another channel.

On the other hand, as illustrated in FIG. 13, each of the edge raster images 29_1 may overlap during printing to form a section, and in this case, the overlapping section may have a different thickness value due to overlapping printing. Accordingly, an average value of thickness information is applied to each overlapping section in which the edge raster images 29_1 overlap. Here, the average value of the thickness information is selected from data values between 0 and 65535 according to the thickness value from the data between 0 and 65535 as described above to generate thickness information, and instead of generating thickness information by sequentially searching pixels for each layer as in the conventional method, when the value corresponding to the coordinate information overlaps, the overlapping thickness value is added to the preset thickness value, and then the average value is applied in real time to generate the thickness information. Thus, during the computation of the thickness of overlapping sections, the pixel searching operation is omitted, so that the time for generating droplet images may be reduced.

The halftoning unit 29a halftones each of the cell raster image 27a, the fence raster image 28a, and the edge raster image 29_1 to generate a cell halftone image 29_2, a fence halftone image 29_3, and an edge halftone image 29_4, as illustrated in FIG. 14. In this case, the halftoning unit 29a may halftone each of the cell halftone image 29_2, the fence halftone image 29_3, and the edge halftone image 29_4 separately.

The droplet image management unit 29b stores the cell halftone image 29_2, the fence halftone image 29_3, and the edge halftone image 29_4 as droplet images, and transmits the droplet images to the inkjet system 10. The inkjet system 10 then prints the droplet image onto the substrate w. Here, the droplet image is used to print an encapsulation layer in the form of a thin film in each cell formed on a display substrate. However, the present invention does not limit the use of the droplet image to being used on a display substrate, and the droplet image may be used on various substrates, such as display substrates, solar substrates, semiconductor substrates, and the like. Furthermore, the droplet image may be used to form various layers, such as an organic light emitting layer, an insulating layer, a conductive layer, or an encapsulation layer, on the above substrates.

The following describes a droplet image generating method using the droplet processing device described above.

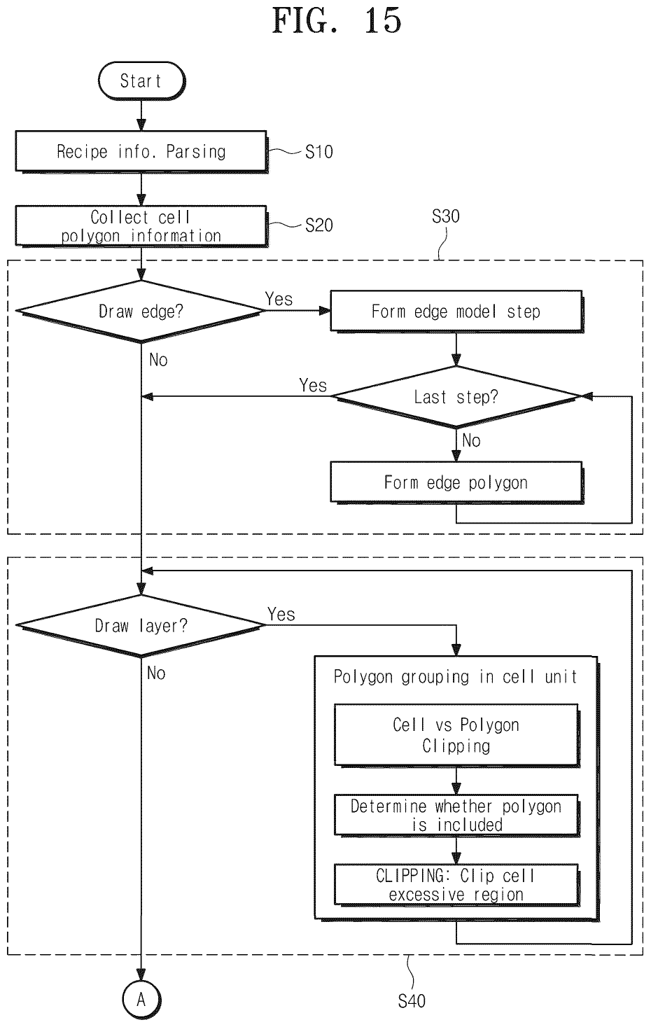

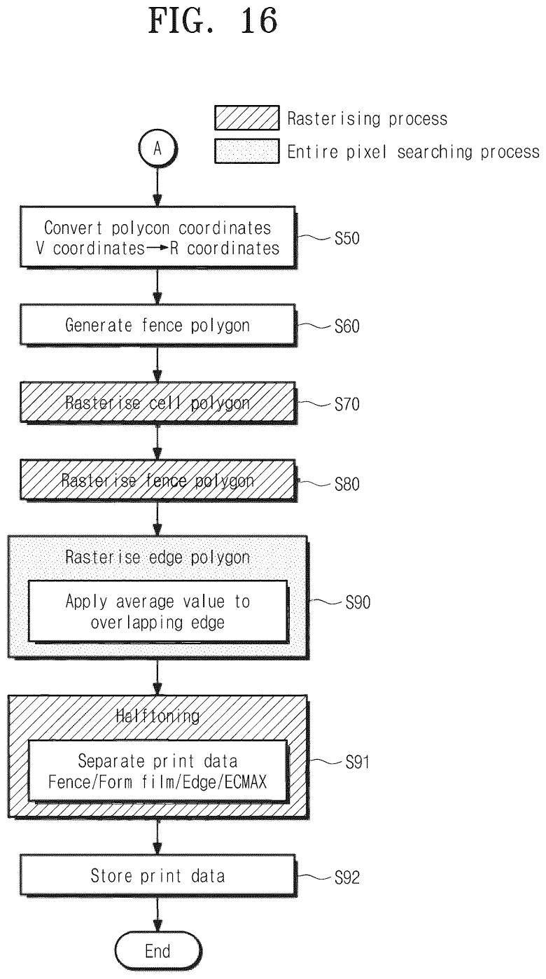

FIGS. 15 and 16 are flowcharts of a droplet image generating method using the droplet processing device according to an exemplary embodiment of the present invention.

Referring further to FIGS. 15 and 16, in a droplet image generation method using the droplet processing device according to an exemplary embodiment of the present invention, the size information generating unit 21 first generates size information 21a for each cell by parsing a circuit pattern file for cells generated on a substrate (S10).

Next, the entire cell polygon information generating unit 22 collects the size information 21a of the cells and generates the collected size information 21a as entire cell polygon information 22a (S20).

Next, the edge polygon information generating unit 23 generates edge polygon information 23a in an edge region of the entire cell polygon information 22a (S30). In this case, the operation to generate the edge polygon information 23a may be performed multiple times when multiple edge polygon information 23a is generated.

Next, after the edge polygon information 23a is generated, the group-specific cell polygon information generating unit 24 groups each of the cells within the entire cell polygon information 22a to generate the group-specific cell polygon information 24a (S40), and in this case, additional polygon information may be further generated inside the cell or the region where the group-specific cell polygon information 24a exceeds may be clipped.

Next, the coordinate converting unit 25 coordinates the vertices that make up the entire cell polygon information 22a, the edge polygon information 23a, and the group-specific cell polygon information 24a, respectively, and converts the coordinated vertices to vertex coordinate information 25a (S50).

Next, the fence polygon information generating unit 26 generates fence polygon information 26a based on the entire cell polygon information 22a (S60). In this case, the scale factor may be applied to the entire cell polygon information 22a as described above.

Next, the cell rasterisation unit 27 rasterises the vertex coordinate information 25a to generate a cell raster image 27a (S70).

Next, the fence rasterisation unit 28 rasterises the fence polygon information 26a to generate the fence raster image 28a (S80).

Next, the edge rasterisation unit 29 rasterises the edge polygon information 23a to generate an edge raster image 29_1 (S90). In the edge raster images 29_1, the overlapping regions may be formed with an average value of the thickness information as described above.

Next, the halftoning unit 29a halftones each of the cell raster image 27a, the fence raster image 28a, and the edge raster image 29_1 to separate and generate a cell halftone image 29_2, a fence halftone image 29_3, and an edge halftone image 29_4 (S91).

Next, the droplet image management unit 29b stores the cell halftone image 29_2, the fence halftone image 29_3, and the edge halftone image 29_4 as droplet images (S92), and transmits the droplet images to the inkjet system. Then, the inkjet system 10 prints the droplet image onto the substrate w.

The droplet image generating method according to the exemplary embodiment of the present invention includes a total of three times of rasterisation processes and a total of one time of entire pixel search operation within the image.

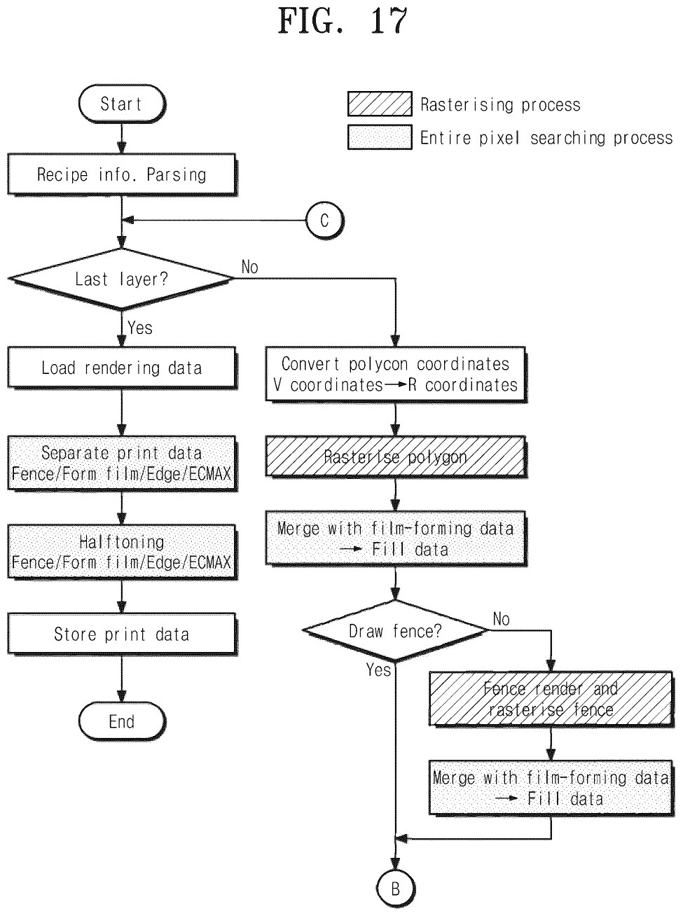

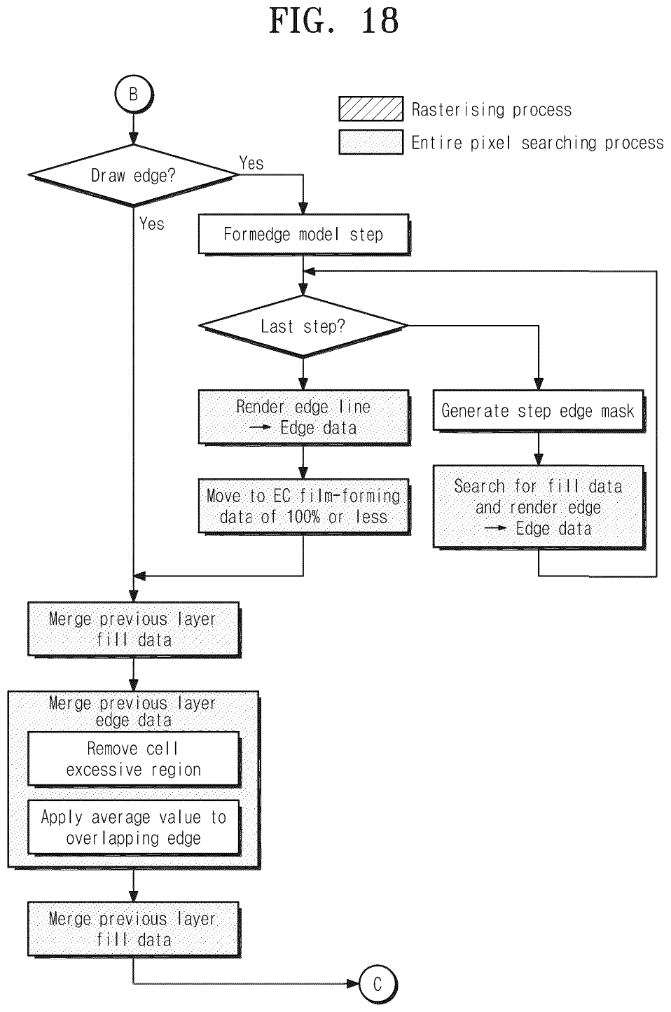

For comparison, reviewing the droplet image generating method in which 8BPP image layers overlap and are printed, FIGS. 17 and 18 are flowcharts comparing the method of forming a layer for each of the cell region, the edge region, the fence region, and the maximum thickness (EC MAC) region corresponding to a thin film by using an 8BPP image with the droplet image generation method of the present invention.

Referring further to FIGS. 17 and 18, since the 8BPP image overlaps by forming a layer for each of the cell region, the edge region, the fence region, and the maximum thickness (EC MAC) region, only two times of rasterisation processes are performed, but a total of 10 times of pixel search processes are performed. As a result, the operation for generating the final droplet image for an A3 (6G Half) glass with a resolution of 3.9 billion pixels takes approximately 14 minutes.

However, when the droplet image generation method using the droplet processing device according to the exemplary embodiment of the present invention is used, the pixel search operation is performed only once in the end without the need to perform the pixel search operation in each operation section, so that the droplet image generation time is reduced to 20 seconds to 30 seconds, and the productivity is greatly increased.

As described above, the present invention has been described with reference to the specific matters, such as a specific component, limited exemplary embodiments, and drawings, but these are provided only for helping general understanding of the present invention, and the present invention is not limited to the aforementioned exemplary embodiments, and those skilled in the art will appreciate that various changes and modifications are possible from the description.

Therefore, the spirit of the present invention should not be limited to the described exemplary embodiments, and it will be the that not only the claims to be described later, but also all modifications equivalent to the claims belong to the scope of the present invention.

What is claimed is:

1. A droplet processing device, comprising:
an inkjet system which receives a droplet image and applies ink for the droplet image to be printed on a substrate; and
a droplet image generating terminal which transmits the droplet image to the inkjet system,
wherein the droplet image is generated by collecting a plurality of cell print data printed on the substrate and a peripheral print data printed on a periphery of the cell into single polygonal information, rasterizing the collected polygonal information and then halftoning.

2. The droplet processing device of claim 1, wherein the droplet image generating terminal further includes a size information generating unit which generates a size information of each cell by parsing a circuit pattern file for the cells generated on the substrate.

3. The droplet processing device of claim 2, wherein the droplet image generating terminal further includes an entire cell polygon information generating unit, which interworks with the size information generating unit and generates entire cell polygon information by collecting the size information of the cells.

4. The droplet processing device of claim 3, wherein the droplet image generating terminal further includes an edge polygon information generating unit which interworks with the entire cell polygon information generating unit and generates edge polygon information in an edge region of the entire cell polygon information.

5. The droplet processing device of claim 4, wherein the edge polygon information is formed by applying a scale factor to the entire cell polygon information to increase or decrease the entire cell polygon information by a certain percentage.

6. The droplet processing device of claim 4, wherein the droplet image generating terminal further includes a group-specific cell polygon information generating unit, which interworks with the edge polygon information generating unit, and generates group-specific cell polygon information by grouping each of the cells in the entire cell polygon information.

7. The droplet processing device of claim 6, wherein the droplet image generating terminal further includes a coordinate converting unit, which interworks with the entire cell polygon information generating unit, the edge polygon information generating unit, and the group-specific cell polygon information generating unit, and coordinates vertices that make up the entire cell polygon information, the edge polygon information, and the group-specific cell polygon information, respectively, and converts the coordinated vertices into vertex coordinate information.

8. The droplet processing device of claim 7, wherein the droplet image generating terminal further includes a fence polygon information generating unit, which interworks with the entire cell polygon information generating unit and generates a fence polygon information based on the entire cell polygon information.

9. The droplet processing device of claim 8, wherein the droplet image generating terminal further includes a cell rasterizing unit, which interworks with the coordinate converting unit and generates a cell raster image by rasterizing the vertex coordinate information.

10. The droplet processing device of claim 1, wherein the droplet image generating terminal further includes a fence rasterizing unit, which interworks with the fence polygon information generating unit and generates a fence raster image by rasterizing the fence polygon information.

11. The droplet processing device of claim 10, wherein the droplet image generating terminal further includes an edge rasterizing unit, which interworks with the edge polygon information generating unit and generates an edge raster image by rasterizing the edge polygon information.

12. The droplet processing device of claim 11, wherein the cell raster image, the fence raster image, and the edge raster image are formed in an image of 16 BPP or more.

13. The droplet processing device of claim 12, wherein the image formed in the 16 BPP or more is that a region information is generated in any one of color information for a red channel, a green channel, and a blue channel.

14. The droplet processing device of claim 13, wherein the image formed in the 16 BPP or more is that a thickness information is generated in at least one color information, except for the color information in which the region information is generated, among the color information for the red channel, the green channel, and the blue channel.

15. The droplet processing device of claim 14, wherein a section in which each of the cell raster images, the fence raster images, and the edge raster images overlaps is a section to which an average value of the thickness information is applied.

16. The droplet processing device of claim 11, wherein the droplet image generating terminal further includes a halftoning unit which generates a cell halftone image, a fence halftone image, and an edge halftone image by halftoning each of the cell raster image, the fence raster image, and the edge raster image.

17. The droplet processing device of claim 16, wherein the droplet image generating terminal further includes a droplet image management unit which stores the cell halftone image, the fence halftone image, and the edge halftone image as the droplet image, and transmits the droplet image to the inkjet system.

18. A droplet processing device, comprising:
an inkjet system which receives a droplet image and applies ink for the droplet image to be printed on a substrate; and
a droplet image generating terminal which transmits the droplet image to the inkjet system,
wherein the droplet image is rasterized into an image of 16 BPP or more during rasterization, and is that a region information is generated in any one of color information for a red channel, a green channel, and a blue channel within the image of 16 BPP or more.

19. The droplet processing device of claim 18, wherein thickness information is generated in at least one color information, except for the color information in which the region information is generated, among the information for the red channel, the green channel, and the blue channel.

20. A droplet processing device, comprising:
an inkjet system which receives a droplet image and which applies ink for the droplet image to be printed on a substrate; and
a droplet image generating terminal which transmits the droplet image to the inkjet system,
wherein the droplet image generating terminal includes:
a size information generating unit which generates a size information of each cell by parsing a circuit pattern file for the cells generated on the substrate;
an entire cell polygon information generating unit which interworks with the size information generating unit and generates entire cell polygon information by collecting the size information of the cells;
an edge polygon information generating unit which interworks with the cell polygon information generating unit and generates edge polygon information in an edge region of the entire cell polygon information, and forms the edge polygon information by applying a scale factor to the entire cell polygon information to increase or decrease the entire cell polygon information by a certain percentage;
a group-specific cell polygon information generating unit which interworks with the edge polygon information generating unit, and generates group-specific cell polygon information by grouping each of the cells in the entire cell polygon information;
a coordinate converting unit, which interworks with the entire cell polygon information generating unit, the edge polygon information generating unit, and the group-specific cell polygon information generating unit, and coordinates vertices that make up the entire cell polygon information, the edge polygon information, and the group-specific cell polygon information, respectively, and converts the coordinated vertices into vertex coordinate information;
a fence polygon information generating unit, which interworks with the entire cell polygon information generating unit and generates a fence polygon information based on the entire cell polygon information;
a cell rasterizing unit, which interworks with the coordinate converting unit and generates a cell raster image by rasterizing the vertex coordinate information;
a fence rasterizing unit, which interworks with the fence polygon information generating unit and generates a fence raster image by rasterizing the fence polygon information;
an edge rasterizing unit, which interworks with the edge polygon information generating unit and generates an edge raster image by rasterizing the edge polygon information;
a halftoning unit, which halftones each of the cell raster image, the fence raster image, and the edge raster image to generate a cell halftone image, a fence halftone image, and an edge halftone image; and
a droplet image management unit, which stores the cell halftone image, the fence halftone image, and the edge halftone image as the droplet image, and transmits the droplet image to the inkjet system, and
the cell raster image, the fence raster image, and the edge raster image are formed in an image of 16 BPP or more,
the image formed in the 16 BPP or more is that a region information is generated in any one of color information for a red channel, a green channel, and a blue channel,
the image formed in the 16 BPP or more is that a thickness information is generated in at least one color information, except for the color information in which the region information is generated, among the color information for the red channel, the green channel, and the blue channel, and
a section in which each of the cell raster images, the fence raster images, and the edge raster images overlaps is a section to which an average value of the thickness information is applied.
